(19) United States
(12) Patent Application Publication
(10) Pub. No.: US 2004/0024729 A1
(43) Pub. Date: Feb. 5, 2004

(54) Method and system for storing sparse data in memory and accessing stored sparse data

(76) Inventor: John S. Worley, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 10/209,374

(22) Filed: Jul. 30, 2002

(51) Int. Cl. G06F 7/00

(52) U.S. Cl. 707/1

(57) ABSTRACT

One embodiment of the present invention provides a hierarchical data structure for storing sparse data that can be traversed from root node to data-level node without incurring translation-cache misses. By contrast with currently used hierarchical data structures, the family of hierarchical data structures that represent one embodiment of the present invention employs non-data-level nodes that contain virtual-memory translations rather than memory references. The family of hierarchical data structures that represent one embodiment of the present invention are traversed from root node through successive layers of non-data-level nodes to data-level nodes in a manner similar to traversal of currently used hierarchical data structures. However, in the family of hierarchical data structures that represent one embodiment of the present invention, the address of a next-lower-level node is computed from a base address of the next-lowest level, and the computed address is furnished, along with the virtual-memory translation stored in a higher-level node, in order to access the next-lower-level node.

### TECHNICAL FIELD

The present invention relates to data structures for storing sparse data and, in particular, to a hierarchical data structure for storing sparse data that may be traversed without incurring translation-cache misses and resulting processing overhead and instruction-stream interruptions.

### BACKGROUND OF THE INVENTION

One embodiment of the present invention is related to processing-efficient storage of sparse data in the memory of a computer system. As will be described below, in detail, tree-like, hierarchical data structures currently employed for storing sparse data may end up distributed over many virtual memory pages within the virtual-memory address space associated with a process within the computer system. Generally, a non-data-level node of the hierarchical data structure references a lower-level node of the hierarchical data structure through a virtual-memory-address reference. In traversing the hierarchical data structure from a root node to the lowest-level, data-containing nodes, a number of memory-access operations based on virtual-memory references contained within the nodes may need to be executed. During a memory access, a virtual-memory address is translated into a physical-memory address. The virtual-memory-address-to-physical-memory-address translation may be short circuited, in the case that a physical-memory translation for the virtual-memory address already resides in a translation cache. If a virtual-memory-address-to-physical-memory-address translation cannot be found in the translation cache, additional processing is required in order to access the physical memory referenced by the virtual-memory address. Each access to data in lower-level, data-containing nodes needs, in general, as many memory-access operations as levels within the hierarchical data structure. In large sparse arrays and other sparse-data-containing data structures, such as page tables used by operating systems, many of the memory operations incur translation-cache misses.

Normally, operating systems store page tables in hierarchical data structures comprising large-sized nodes, generally equal to the size of a virtual-memory page. In the hierarchical data structures used by operating systems to store page tables, many inter-level memory accesses may involve translation-cache misses. Moreover, page tables are generally quite large, while translation caches are normally relatively small, on the order of one hundred to several-hundred entries. The disparity between the number of nodes that may be traversed in a small amount of time and the small size of the translation cache further increases the probability of translation-cache misses during memory-access operations involved in traversing the hierarchical data structure, particularly when memory references made by executing processes are not localized within a small group of virtual-memory pages. Designers and users of sparse-data-containing data structures, and developers, manufacturers and users of operating systems, have recognized the need for a sparse-data-containing data structure that provides the memory efficiency of classical, hierarchical data structures, while avoiding the computational inefficiencies involved in inter-virtual-memory-page memory-reference traversals.

### SUMMARY OF THE INVENTION

One embodiment of the present invention provides a computationally efficient, hierarchical data structure for storing sparse data that can be traversed from root node to data-level node without incurring translation-cache misses. By contrast with currently used, classical, hierarchical data structures, the family of hierarchical data structures that represent one embodiment of the present invention employs non-data-level nodes that contain translation-cache entries rather than memory references. The hierarchical data structures that represent one embodiment of the present invention are traversed, as are currently used, classical, hierarchical data structures, from a root node, through successive layers of non-data-level nodes, to data-level nodes along acyclic traversal paths, each traversal path unique to the data values stored together in a data-level node. However, in the family of hierarchical data structures that represent one embodiment of the present invention, in order to access the next-lower-level node during a traversal along a traversal path, the address of a next-lower-level node is computed from a base address of the next-lowest level, and the computed address is furnished, along with the translation-cache entry stored in a higher-level node, to a memory-access mechanism.

### BRIEF DESCRIPTION OF THE DRAWINGS

FIG. 1 illustrates the virtual-address space defined within the Intel IA-64 computer architecture.

FIG. 2 illustrates translation of a virtual-memory address into a physical-memory address.

FIG. 3 shows the data structures employed by an operating system routine to find a memory page in physical memory corresponding to a virtual-memory address.

FIG. 4 is a flow-control diagram summary of the virtual-address translation mechanism within the IA-64 processor.

FIG. 5 shows a hierarchical data structure commonly employed for storing sparse data.

FIG. 6 illustrates the locations, in memory, of the level-3, level-2, and level-1 nodes of the hierarchical data structure illustrated in FIG. 5.

FIG. 7 illustrates memory locations of the hierarchical levels of a computationally efficient hierarchical data structure that represents one embodiment of the present invention.

FIG. 8 illustrates an example computationally efficient hierarchical data structure that represents one embodiment of the present invention.

FIG. 9 is a flow-control diagram for a virtual address translation mechanism, employed in one embodiment of the present invention, which receives both a virtual-memory address, as well as the translation-cache entry for that address, as inputs.

### DETAILED DESCRIPTION OF THE INVENTION

The present invention relates to data structures for storing sparse data and, more specifically, to a family of types of hierarchical data structures that can be traversed from root node to data-level node without incurring translation-cache misses during virtual-memory-to-physical-memory translation of memory references, or pointers, stored within non-data-level data-structure nodes. The present invention finds particular use in operating systems. Operating systems generally store page tables in hierarchical data structures. Because page-table nodes are often sized according to the size of virtual memory pages, and because the locality of reference of memory accesses encountered during execution of processes within a computer system often exceeds the rather modest size of translation caches, translation-cache misses frequently occur during traversal of the hierarchical data structure. Translation-cache misses are particularly deleterious during execution of operating-system processes. The translation-cache misses may occur in very-low-level operating system routines that lack higher-level operating-system facilities for easily handling translation-cache misses.

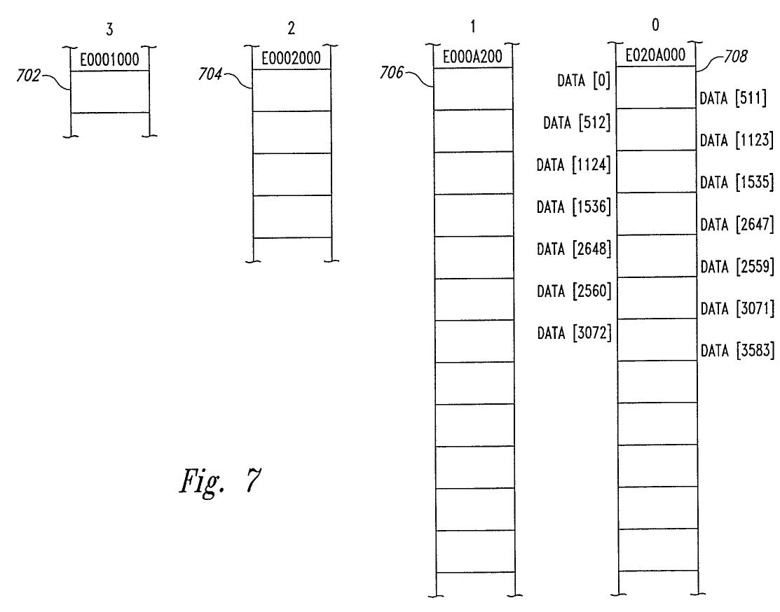

In a first subsection, below, additional details about hierarchical data structures, translation-cache misses, and other related topics are provided. In a second subsection, one embodiment of the present invention is presented with reference to FIGS. 7-9. Finally, in a third subsection, a C++-like pseudocode implementation of one embodiment of the present invention is provided.

### Additional Details Regarding Hierarchical Data Structures, Translation-Cache Misses, and Related Tonics

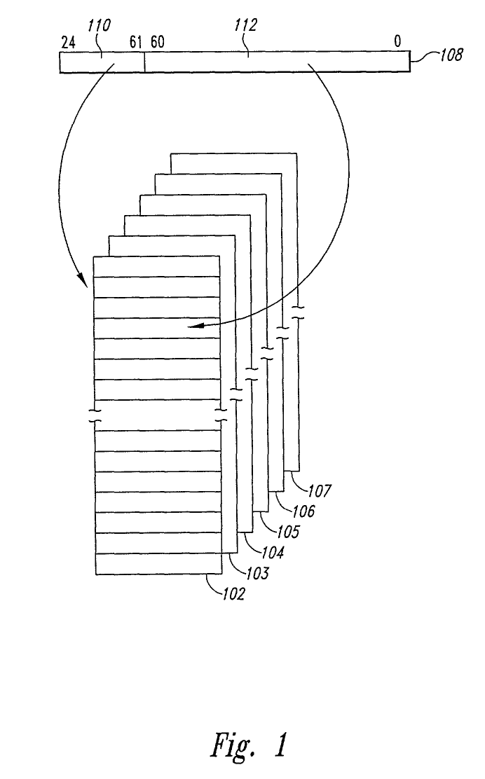

Because the present invention is related to virtual-memory addresses and virtual-memory management, a brief description of the virtual memory and virtual-memory-address-translation architecture of an example processor architecture, the Intel® IA-64 computer architecture, is described below, with references to FIGS. 1-3. The virtual-address space defined within the Intel IA-64 computer architecture includes 2²⁴ regions, such as regions 102-107 shown in FIG. 1, each containing 2⁶¹ bytes that are contiguously addressed by successive virtual-memory addresses. The virtual-memory address space can therefore be considered to span a total virtual-address space of 2⁸⁵ bytes of memory. An 85-byte virtual-memory address 108 can then be considered to comprise a 24-bit region field 110 and a 61-bit address field 112.

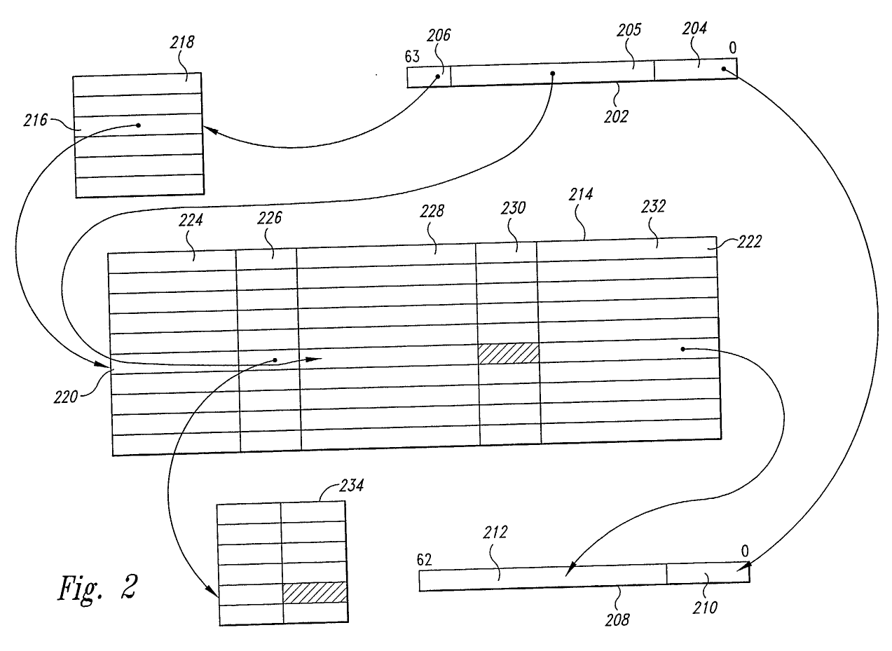

In general, however, virtual-memory addresses are considered to be 64-bit quantities. FIG. 2 illustrates translation of a virtual-memory address into a physical-memory address via information stored within region registers, protection key registers, and a translation look-aside buffer (“TLB”). In the Intel® IA-64 architecture, virtual addresses are 64-bit computer words, represented in FIG. 2 by a 64-bit quantity 202 divided into three fields 204-206. The first two fields 204 and 205 have sizes that depend on the size of a memory page, which can be adjusted within a range of memory page sizes. The first field 204 is referred to as the “offset.” The offset is an integer designating a byte within a memory page. If, for example, a memory page contains 4096 bytes, then the offset needs to contain 12 bits to represent the values 0-4095 in the binary number system. The second field 205 contains a virtual-page address. The virtual-page address designates a memory page within a virtual address-space that is mapped to physical memory, and further backed up by memory pages stored on mass storage devices, such as disks. The third field 206 is a three-bit field that designates a region register containing the identifier of a region of memory in which the virtual-memory page specified by the virtual-page address 205 is contained.

The processor, at times in combination with kernel and operating-system routines, carries out translation of a virtual-memory address 202 to a physical-memory address 208 that includes the same offset 210 as the offset 204 in the virtual-memory address, as well as a physical-page number 212 that references a page in the physical-memory components of the computer system. If a translation from a virtual-memory address to a physical-memory address is contained within the TLB 214, then the virtual-memory-address-to-physical-memory-address translation can be entirely carried out by the processor without operating-system intervention. The processor employs the region-register-selector field 206 to select a register 216 within a set of region registers 218. The selected region register 216 contains a region identifier. The processor uses the region identifier contained in the selected region register and the virtual-page address 205 together in a hash function to select a TLB entry 220. Alternatively, the TLB can be searched for an entry containing a region identifier and virtual-memory address that match the region identifier contained in the selected region register 216 and the virtual-page address 205. Each TLB entry, such as TLB entry 222, contains fields that include a region identifier 224, a protection key associated with the memory page described by the TLB entry 226, a virtual page address 228, privilege and access mode fields that together compose an access rights field 230, and a physical memory page address 232.

If an entry in the TLB can be found that contains the region identifier contained within the region register specified by the region-register-selector field of the virtual-memory address, and that contains the virtual-page address specified within the virtual-memory address, then the processor determines whether the virtual-memory page described by the virtual-memory address can be accessed by the currently executing process. The currently executing process may access the memory page if the access rights within the TLB entry allow the memory page to be accessed by the currently executing process and if the protection key within the TLB entry can be found within the protection key registers 234 in association with an access mode that allows the currently executing process access to the memory page. The access rights contained within a TLB entry include a 3-bit access mode field that indicates one, or a combination of, read, write, and execute privileges, and a 2-bit privilege level field that specifies the privilege level required of an accessing process. Each protection-key register contains a protection key associated with an access mode field specifying allowed access modes and a valid bit indicating whether or not the protection key register is currently valid. Thus, in order to access a memory page described by a TLB entry, the accessing process must access the page in a manner compatible with the access mode associated with a valid protection key within the protection-key registers and associated with the memory page in the TLB entry and must be executing at a privilege level compatible with the privilege level associated with the memory page within the TLB entry.

If an entry is not found within the TLB with a region identifier and a virtual page address equal to the virtual page address within the virtual-memory address and a region identifier selected by the region-register-selector field of a virtual-memory address, then a TLB miss occurs, and a processor function, generally in combination with kernel or operating-system routines, is invoked in order to find the specified memory page within physical memory, if necessary, loading the specified memory page from an external device into physical memory, and then inserting the proper translation as an entry into the TLB. If, upon attempting to translate a virtual-memory address to a physical memory address, the processor does not find a valid protection key within the protection key registers 234, or if the attempted access by the currently executing process is not compatible with the access mode in the TLB entry or the read/write/execute bits within the protection key in the protection key register, or the privilege level at which the currently executing process executes is less than the privilege level associated with the TLB entry, then a fault occurs that is handled by a kernel routine that dispatches execution to an operating system routine.

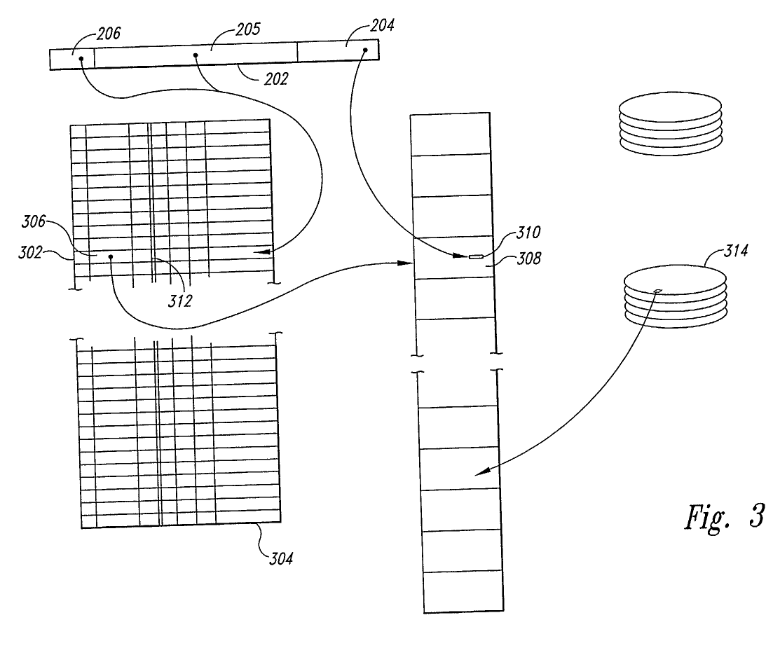

FIG. 3 shows the data structures employed by a processor function, often in combination with an operating system routine, to find a memory page in physical memory corresponding to a virtual-memory address. The virtual-memory address 402 is shown in FIG. 3 with the same fields and numerical labels as in FIG. 2. A processor function, referred to, in the IA-64 architecture as a “VHPT walker,” employs the region selector field 406 and the virtual-page address 405 to select an entry 302 within a virtual page table 304 (“VHPT”). The virtual-page table entry 302 includes a physical page address 306 that references a page 308 in physical memory. The offset 404 of the virtual-memory address is used to select the appropriate byte location 310 in the virtual memory page 308. The virtual page table 302 includes a bit field 312 indicating whether or not the physical address is valid. If the physical address is valid, a TLB entry is inserted in the TLB corresponding to the VHPT and the fault handler can return. If the physical address is not valid, then the operating system selects a memory page within physical memory to contain the memory page, and retrieves the contents of the memory page from an external storage device, such as a disk drive 314. The virtual page table entry 302 contains additional fields from which the information required for a TLB entry can be retrieved. If the operating system successfully translates the virtual-memory address into a physical-memory address, that translation, is inserted as a virtual page table entry into the VHPT and as a TLB entry into the TLB.

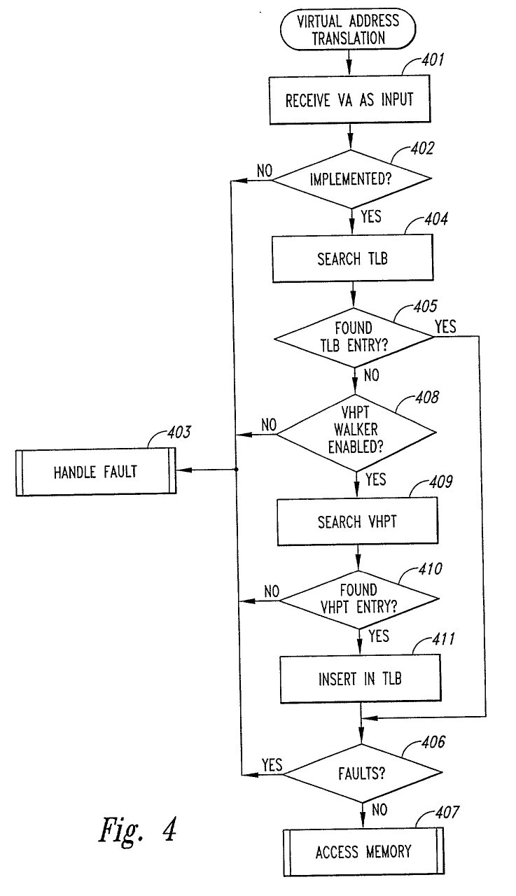

FIG. 4 is a flow-control diagram summary of virtual-address translation within the IA-64 processor. Note that this virtual-address translation is similar, in many aspects, to those used in many other modern computer processors. The flow-control diagram of FIG. 4 is constructed in the form of a software routine, for illustrative purposes, but many of the steps of virtual-memory-address translation may be carried out at the processor hardware and firmware levels.

In step 401, the routine “Virtual Address Translation” (“VAT”) receives, as input, a virtual-memory address. In step 402, VAT determines whether or not the virtual-memory address lies within a range of implemented virtual-memory addresses. If not, then a fault handler is called in step 403. Otherwise, in step 404, VAT searches the translation-cache for a translation-cache entry containing the virtual-address-to-physical-address translation for the virtual-memory address. If the translation-cache entry is found, as determined by VAT in step 405, then control flows to step 406, in which VAT prepares to access the physical memory corresponding to the virtual-memory address. If one of numerous different fault conditions is detected by VAT, in step 406, an appropriate fault handling routine is called, in step 403. Otherwise, in step 407, VAT proceeds to access the physical memory corresponding to the virtual-memory address. However, referring back to step 405, if a translation-cache entry for the virtual-memory address is not found in the translation-cache, then VAT determines, in step 408, whether the VHPT walker, a processor mechanism for searching the VHPT, is enabled. If the VHPT walker is not enabled, then an appropriate fault handler is called in step 403. Otherwise, the VHPT walker searches the VHPT, in step 409, for a VHPT entry that includes a translation for the virtual-memory address. If a VHPT entry cannot be found, as determined by VAT in step 410, then an appropriate fault handler is called in step 403. Otherwise, in step 411, the information in the VHPT entry is extracted and stored in a translation-cache entry in step 411.

As can be readily seen in FIG. 4, there may be a significant performance penalty for a translation-cache miss, or, in other words, for failing to find, in step 404, a translation-cache entry for the received virtual memory address. The VHPT must at least be searched for a corresponding VHPT entry. The VHPT walker uses at least 12 instruction cycles to compute the cache value for the virtual-memory address in order to find a VHPT entry for the virtual-memory address. Moreover, execution of the VHPT walker may interrupt instruction pipelining, and therefore may introduce increased instruction-execution latency.

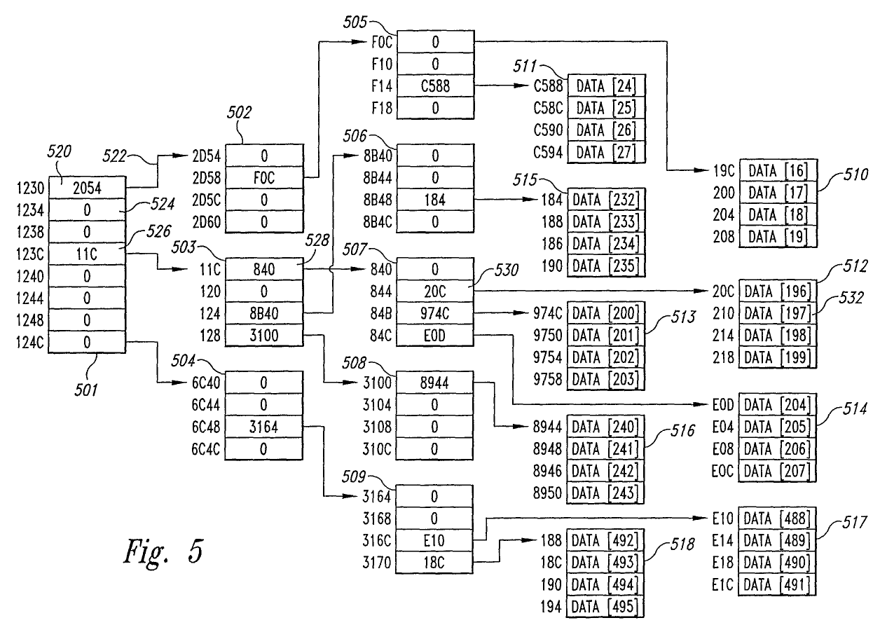

FIG. 5 shows a hierarchical data structure commonly employed for storing sparse data, such as a single-dimension, sparse array “data.” A sparse array is an array in which the majority of entries are either not defined or are implicitly 0 or some other distinguished value. For example, the array “data” may contain a number of 32-bit integer entries with indices ranging from 0 to 511. In other words, the array “data” may be declared, in a C-like languages, as follows:

int data [512];

In the example illustrated in FIG. 5, values for entries with indices 16-19, 24-27, 196-207, 232-235, 240-243, and 488-495 have been inserted into the array “data,” and all other data entries are undefined. If it is known, in advance, that the array “data” will be sparsely populated, then it is inefficient, with respect to memory usage, to allocate memory for the entire set of 512 potential data entries. Instead, a hierarchical data structure, such as that shown in FIG. 5, can be employed to represent the sparse array “data.” For example, as shown in FIG. 5, the hierarchical data structure, including lowest-level nodes that store data values, takes up 76 32-bit words, rather than the 512 32-bit words that would be needed for allocating the entire 512-entry array.

There are many different types of hierarchical data structures that can be used to represent a sparse array or to store sparse data. The hierarchical data structure illustrated in FIG. 5 is representative of one of many different types of hierarchical data structures. The hierarchical data structure of FIG. 5 comprises a number of small blocks of memory, such as memory block 502. The blocks of memory, referred to as “nodes,” are arranged in levels. In FIG. 5, the levels are represented as vertical columns of nodes. Node 501 is the only node in the highest level of the data structure, designated level 3. Nodes 502-504 together compose the next highest level of the data structure, level 2. Nodes 505-509 together compose level 1, and nodes 510-518 together compose the lowest level of the hierarchical data structure, level 0.

The nodes of levels 1, 2, and 3 contain virtual-memory addresses, represented as hexadecimal integers. The virtual-memory addresses for the entries of a node appear to the left of the node. Thus, for example, the first entry 520 in node 501 contains the address 0x2054, which is the address of the first entry in node 502. It is common to represent address entries as memory references, or pointers, using arrows, such as arrow 522 that indicates that the address stored in node entry 520 references, or points to, node 502 or, more exactly, to the first entry of node 502.

The nodes of any particular level have a fixed number of entries. In the data structure shown in FIG. 5, the nodes of levels 0, 1, and 2 all have four entries, while the single root node of level 3 has 8 entries. A distinguished value, the value 0 in the example of FIG. 5, is stored in certain node entries to indicate that no value or address has been defined for that entry. For example, the value stored in the second entry 524 of the root node 501 is 0, indicating that no level-2 node has been allocated. In FIG. 5, only those level-2 and level-1 nodes necessary for referencing data nodes 510-518 have been allocated. Thus, the hierarchical data structure of FIG. 5 represents a sparse array, with only those nodes allocated that are necessary to reference the stored data.

In order to access a particular data value, for example the data value stored in the storage location described as “data[197],” the following procedure is employed. First, the index of the desired data value, 197, is divided by the number of indices referenced by each memory-reference entry in the root node. Each root-node memory-reference entry references a level-2 node, which in turn, may reference up to four level-1 nodes, each of which may, in turn, reference up to four data-level nodes. Thus, each memory-reference entry in the root node may potentially reference a total of 4*4, or 64, stored data values. Because the root node contains 8 memory-reference entries, the root node can reference a total of 512 stored data values. Thus, by dividing the index of the desired data value, 197, by 64, the index of the memory-reference entry in the root node 501 can be determined for the data value with index 197. Integer division of 197 by 64 provides the desired root-node index “3.” Starting from a known address of the root node, 0x1230, the root-node memory-reference entry 526 containing the memory reference 0X11C can be obtained using the index “3” produced by dividing 197 by 64 and the size, in addressable units, of a root-node entry. The remainder of the integer division, 197 mod 64=5, is then employed in similar fashion at the next-level node. Because each level-2 node memory-reference entry references a total of 4*4=16 data values, the remainder 5 can be divided by 16 to determine the index in the level-two node, node 503, that contains the level-2 memory reference corresponding to the data value within index 197. Integer division of 5 by 16 produces index “0.” The first memory-reference entry 528 of node 503, corresponding to index “0,” is then employed to find the level-1 node corresponding to the data value with index 197. Using the remainder 5 mod 16=5 from the previous division, the index in the level-1 node corresponding to the data value with index 197 can be determined by dividing the remainder from the previous division, “5,” by the number of data values that can be accessed by each memory-reference entry in a level-1 node, 4. Integer division of 5 by 4 produces the index “1” with a remainder of “1.” Using the level-1 node index of “1,” the memory-reference 530, pointing to data-level node 512 that contains the data value with index 197, is obtained. The remainder from the previous division, 1, is then the index of the data value within the referenced data-level node 512. Thus, the data-level node entry 532 is determined to contain the data value with index 197 or, in other words, data[197].

The addresses in the above example are based on 32-bit addresses and 32-bit integer data values. A similar hierarchical data structure can be used to store data values of any size. Furthermore, the sizes of the nodes at each level can be arbitrarily defined, and the number of levels can be, as well, arbitrarily defined, in order to produce a hierarchical data structure that can store a number of data entries up to the number of data entries that can be contained, along with the necessary higher-level nodes, within a particular memory. There are many variations of hierarchical data structures for storing sparse arrays, and many of these can be found in commonly available computer-data-structure textbooks. Moreover, the non-data-level nodes may be stored in memory, while data-level nodes may be stored on a mass storage device, or, in an alternative view, a hierarchical data structure may contain mass-storage-device addresses as data in the lowest non-data-level nodes. The present invention is related to the family of hierarchical data structures that employ one or more discrete, non-data-level nodes that contain memory references that point to lower-level nodes of the data structure.

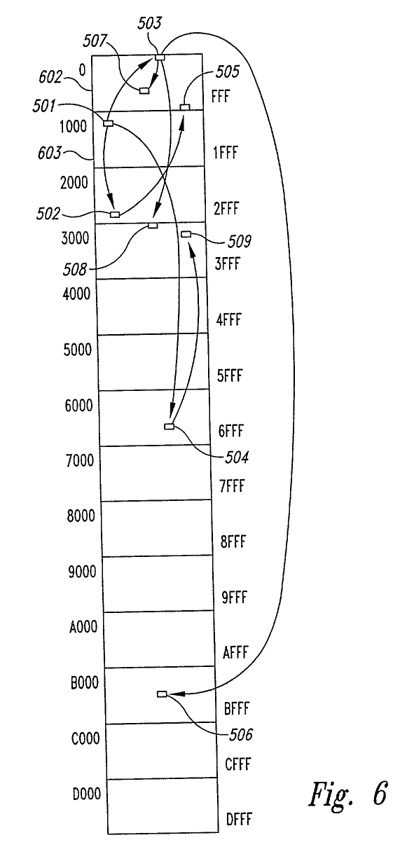

FIG. 6 illustrates the locations, in memory, of the level-3, level-2, and level-1 nodes of the hierarchical data structure illustrated in FIG. 5. FIG. 6 assumes a virtual-memory page size of 4096 bytes, each byte of which is addressable. Thus, virtual memory page 0 (602 in FIG. 6) includes virtual-memory addresses 0 through 0×FFF. Virtual memory page 1 (603 in FIG. 6) includes virtual-memory addresses 0x1000 through 0×1FFF. The first entry of the root node is located at virtual-memory address 0x1230, in virtual memory page 1 (603 in FIG. 6). The level-2 nodes 502-505 are located in virtual memory pages 2, 0, and 6, respectively. The data-level nodes are not shown in FIG. 6, but, if shown, would be seen to be also distributed across many different virtual-memory pages. The distribution of nodes across a virtual-memory address space depends on the memory allocation method employed and on the sequence of node allocations.

Whenever a memory-reference entry of one node, such as the memory-reference entries in the root node 501, references a lower-level node on another virtual-memory page, memory-access operations involved in de-referencing the memory-reference entry in order to access the virtual-memory page containing the lower level node involve the virtual-address translation mechanism shown in FIG. 4. In particular, each memory-access operation from one virtual-memory page to another virtual-memory page may involve a translation cache miss, and therefore may involve steps 408-411 and 403 in FIG. 4. Translation-cache misses always incur, on the IA-64 , at least 12 additional processor cycles, which generally cause interruption of instruction pipelining and increased instruction-execution latencies, and may further incur various types of memory fault handling. Thus, although the hierarchical data structure greatly decreases the amount of memory needed to be allocated for storing sparse arrays and other sparse data, such as page tables in an operating system, access of any particular data value within the hierarchical data structure is computationally less efficient than access of indexed data stored within a fully allocated, non-sparse array. When translation-cache misses are incurred during traversal of the data structure, the computational inefficiency can greatly increase.

### One Embodiment of the Present Invention

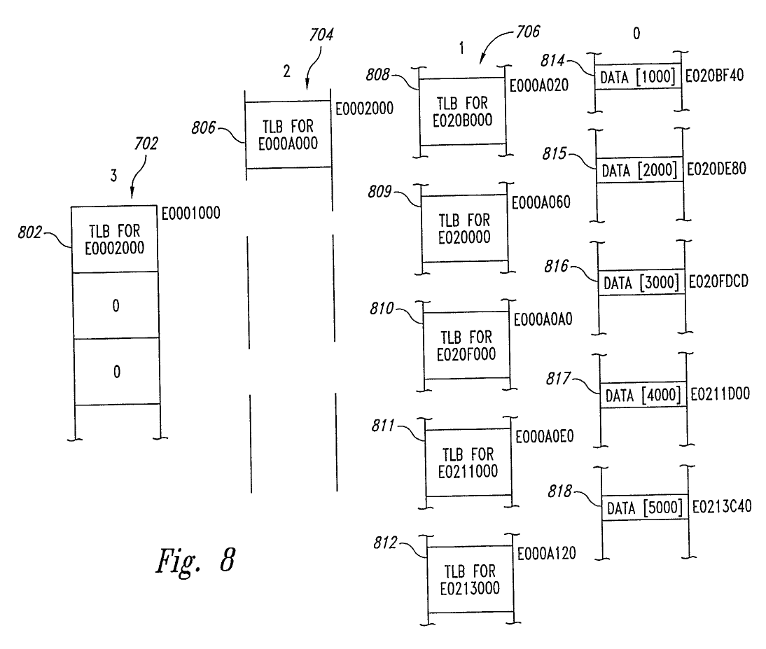

FIGS. 7 and 8 illustrate a representative, computationally efficient hierarchical data structure (“CEHDS”) that represents one embodiment of the present invention. In the example CEHDS illustrated in FIGS. 7 and 8, nodes are sized according to the size of virtual-memory pages, assumed for the example to be 4096 bytes. The CEHDS of FIGS. 7-8 represents a sparse array of 64-bit integers in a 64-bit virtual-memory-address architecture, such as that of the Intel® IA-64 processor architecture described above. FIG. 7 illustrates how the hierarchical levels of the CEHDS are laid out in memory. The top level, in this case level 3, containing the root node 702, begins at virtual-memory address 0xE000A000. Level-2, including the first level-2 node 704, begins at virtual-memory address 0xE0002000. Level-1, including the first level-1 node 706, begins at virtual-memory address 0xE000A000. Finally, the data level, or level-0, including the first level-0 node 708, begins at virtual-memory address 0xE020A000. In the example CEHDS of FIG. 7, a data-level node, such as data-level node 708, includes 512 64-bit integers, each represented in FIGS. 7-8 as an element of a sparse array “data.” The non-data-level nodes contain 32-byte translation-cache entries. Note that the nodes within a level are laid out contiguously in virtual memory, starting with the base level address, as shown in FIG. 7. Because the nodes of any particular level have a single fixed size, the address of any particular node within a level can be easily computed from the base virtual address of the level and an integer index for the node, as follows:

node address=base-level address+(node size*node index*entry size)

FIG. 8 illustrates the example CEHDS, shown laid out in memory in FIG. 7, containing five data values: data[1000], data[2000], data[3000], data[4000], and data[5000]. All five data values are referenced from a single entry 802 in the root node 804 and from a single entry 806 in the first node 704 of level 2. The five data values are referenced by five different entries 808-812 in the first level-1 node 706. The five data values are contained in five different data-level nodes 814-818.

Unlike in the hierarchical data structure illustrated in FIG. 5, the example CEHDS, shown in FIGS. 7-8, contains translation-cache entries rather than memory references in non-data-level nodes. Thus, for example, the first entry 802 in the root node 702 includes the translation-cache entry for virtual-memory address 0xE0002000, the address of the first node 704 in level 2. In other words, the CEHDS of FIGS. 7 and 8 is similar to the classical hierarchical data structure of FIG. 5, except that, rather than memory references, the non-data-level nodes contain translation-cache entries corresponding to the virtual-memory addresses that would be contained in the nodes of the classical hierarchical data structure shown in FIG. 5.

Traversal of the CEHDS is carried out in a different fashion from traversal of the classical hierarchical data structure of FIG. 5. For example, consider traversing the CEHDS in order to locate the data value “data[5000].” At each point in the traversal of the CEHDS shown in FIG. 8, or, in other words, at each level of the CEHDS reached during a traversal of the CEHDS along a traversal path, the index of the node traversed at a current level has been computed during traversal of a node at the previous level, and the index of the entry in the node being traversed at the current level must be computed, based on a remaining data index, in order to obtain the translation-cache entry contained within the currently-traversed node for accessing the node at the next lowest level of the CEHDS. At the root level, the remaining data index is the index of the data entity that is being accessed via the traversal of the CEHDS, and the index of the currently traversed node is 0, since there is only a single node at the root level.

In order to locate the address of the data entity corresponding to data[5000], the CEHDS is traversed, beginning at the root level, or level 3. First, the index for the entry within the root node is computed by dividing the remaining data index, 5000, by the number of data entities ultimately referred to by each entry of the root node, namely 128 entries in a level-2 node*120 entries in a level-1 node*512 entries in a data-level node=8,388,608. Integer division of 5000 by 8,388,608 produces a result of 0 with a remainder of 5000. The remaining data index is set to the remainder of the integer division, 5000. To compute the address of the entry in the root node, the index of the relevant node of the previous level, in the case of the root node, 0, is multiplied by the size, in entries of the root node, and to this value is added the entry index computed in the above integer division to produce an offset. The offset is multiplied by the size, in addressable units, of an entry and added to the base virtual address for the root level, 0xE0001000, to produce the address of the entry in the root-level node that ultimately refers to the data-level block containing the data value data[5000]. Thus, the address for the relevant entry of the root node=0xE0001000+((0*128)+0)*32=0Xe0001000. The translation-cache entry for the level-2 virtual-memory page containing the level-2 node that is the next node in the traversal of the CEHDS is obtained from memory starting at the computed address 0xE0001000. Note, in FIG. 8, that the translation-cache entry for the virtual-memory page beginning at address 0xE0002000 is stored in the first entry 802 of the root node 702. Thus, the node index for the root-level node is computed to be 0, the entry index for the root-level node is computed to be 0, as well, and the translation-cache entry for the level-2 node has been obtained from entry 0 of node 0 at the root level. Finally, the index for the level-2 node can be computed as the current node index*the size, in entries, of the current node added to the entry index of the currently traversed entry within the currently traversed level-3 node=(0*128)+0=0.

The traversal then continues to level-2. The index for the relevant level-2 node is 0, as computed above. The index for the entry within the 0th level-2 node is computed by dividing the remaining data index, 5000, by the number of data entities ultimately referenced by a level-2-node entry: 128 entries in a level-1 node*512 entries in a data-level node=65,536. Thus, 5000/65,536=0, the entry index within the level-2 node on the traversal path to data value data[5000]. The address of the relevant level-2 entry is then computed as: the level-2 node index 0*the level-2 block size 128+the entry index 0, the sum multiplied by the entry size for a non-data-level node, 32, and then added to the virtual base address for level-2, 0xE0002000 to produce the entry address 0xE0002000. The translation-cache for the virtual-memory page containing the level-1 node on the traversal path to data value “data[5000]” can then be accessed from the level-2 node starting at virtual-memory address 0xE0002000 using the translation-cache entry for the virtual-memory page containing the level-2 node obtained from the first entry 802 of the root node 702 during traversal of the previous level.

The process is again repeated at level-1. The current node index, computed as was the current node index during traversal of level-3, is 0. The entry index within the 0th level-1 node is the remaining data index, 5000, divided by the number of data entities potentially referenced by a level-1-node entry, 512, which produces the entry index “9,” with a remainder of 392. Thus, the entry index for the 0th level-1 node is 9, and the address for the relevant level-1 entry is obtained by multiplying the current node index 0*the size, in entries, of a level-1 node, 128, and adding the entry index 9 to produce an entry offset of 9. 9 * the size, in bytes, of a translation-cache entry, 0x20,=0x120, which is added to the virtual base address for level-1, 0xE000A020, to produce the virtual-memory address for the 9th entry in the 0th level-1 node, 0xE000A120. The translation-cache entry for the data-level virtual memory page containing data value “data[5000]” can then be obtained starting at virtual-memory address 0xE000A120 using the translation-cache entry obtained for the virtual-memory page containing the 0th level-1 node obtained from the 0th entry of the first level-2 node 806.

Finally, in similar fashion, the node index and entry index for the data-level node can be computed. The node index is the node index for the node in the previous level, 0, multiplied by the block size, in entries, for a level-1 node+the entry-index for the level-1 node, 9, or (0*128)+9=9. The entry index is the remaining data index, 392. Thus, the address of the data value “data[5000]” is the virtual-memory base address for level-0, 0xE020BF40, added to 9*the block size, in entries, of a level-0 node+392, the sum then multiplied by the size, in bytes, of a data value 8,=0xE0213C40. Note that, in FIG. 8, the data value “data[5000]” resides starting at virtual-memory address 0xE0213C40 within the 9th data-level node 818.

In summary, traversal of the CEHDS differs from traversal of a classical hierarchical data structure in that, rather than using internal memory-reference entries to navigate from the current node to a next lowest-level node, a translation-cache entry for the virtual-memory page of the next lowest node is extracted from the current node and combined with a calculated virtual-memory address for the relevant entry in the next lowest node in order to access the next lowest node. In other words, during traversal of the CEHDS, the virtual-memory addresses for nodes are calculated, based on the virtual-base memory addresses levels within the CEHDS, and the calculated virtual-memory addresses are combined with translation-cache entries corresponding to those virtual-memory addresses in order to access the contents of a node entry described by the calculated virtual-memory addresses and translation-cache entries.

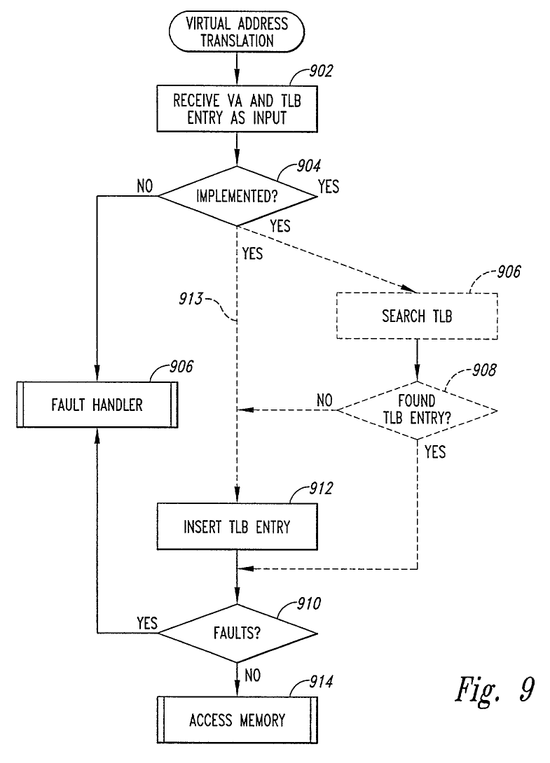

FIG. 9 is a flow-control diagram for a virtual address translation method that receives both a virtual-memory address as well as the translation-cache entry for that address, as inputs. This virtual address translation method is used for memory accessed during traversal of the family of CEHDS that represent one embodiment of the present invention. In step 902, the routine “Virtual Address Translation 2” (“VAT-2”) receives a virtual-memory address to translate, as well as the translation-cache entry corresponding to that address. In step 904, VAT-2 determines whether or not the received virtual-memory address is implemented in the computer system. If not, then an appropriate fault handler is called in step 906. Otherwise, two different optional paths may be chosen, depending on the efficiency of the paths in a given machine architecture. In the first path, the translation-cache is searched for the translation-cache entry corresponding to the supplied virtual-memory address. If the translation-cache entry is found, as determined in optional step 908, then control flows to step 910. Otherwise, control flows to step 912, in which VAT-2 inserts the received translation-cache entry into the translation-cache. A second, optional path is represented by dashed arrow 913. In the second, optional path, VAT-2 simply inserts the received translation-cache entry into the TLB, or translation cache, in step 912, without first searching the translation-cache for the entry. If insertion of a translation-cache entry is as fast as searching the translation-cache for a given translation-cache entry, then the second optional path, comprising step 912, is preferred. In either case, once the translation-cache entry has been inserted into the translation-cache or found in the translation-cache, VAT-2 determines, in step 910, whether any memory faults will occur as a result of preparing to accessing memory and, if so, an appropriate fault handler is called in step 906. Otherwise, the physical memory corresponding to the supplied virtual-memory address is accessed in step 914.

Comparison of the virtual address translation routine shown in FIG. 9 with that shown in FIG. 4 illustrates the elimination of translation-cache misses when both a virtual-memory address and the translation-cache entry corresponding to the virtual-memory address are supplied to a virtual-address translation routine. Again, as with FIG. 4, the flow-control diagram of FIG. 9 is presented in the form of a software routine, although the virtual-address translation method is at least partially implemented in hardware and firmware.

### C++-Like Pseudocode Implementation of the Present Invention

In the following C++-like pseudocode, an implementation of a currently used, hierarchical data structure used for a sparse array is provided. This pseudocode essentially implements the hierarchical data structure illustrated in FIG. 5. The pseudocode is adapted, for illustrative purposes, to clearly point out memory accesses involved in traversing the data structure, and is essentially a simulation of a classical hierarchical data structure:

```
  1 #include <stdio.h>
  2 #include <stdarg.h>
  3 const int DATA_SIZE = 1;
  4 const int ADDRESS_SIZE = 1;
  5 const int MAX_LEVEL = 10;
  6 const int DISTINGUISHED_VALUE = 0;
  7 const int DISTINGUISHED_DATA_VALUE = −100000000;
  8 typedef int* address;
  9 typedef int Address;
10 typedef int data;
11 #define ACCESS_MEMORY(x) *(x)
12 #define ALLOCATE_MEMORY(x) new x
```

The above 12 lines include various constant definitions, type declarations, and defined macro routines used in the following pseudocode, both for clarity and to simulate various low-level routines. The constants “DATA_SIZE” and “ADDRESS_SIZE,” declared above on lines 3-4, represent the size, in addressable units, of a data value and a memory reference, respectively. The constant “MAX_LEVEL,” declared above on line 5, represents the maximum number of levels allowed by the implementation within the classical hierarchical data structure. The constants “DISTINGUISHED_VALUE” and “DISTINGUISHED_DATA_VALUE,” declared above on lines 6 and 7, represent distinguished values for memory-reference entries and data-value entries, respectively. Thus, a memory reference having the distinguished value “0” represents a null pointer, while a data-value entity having the value “−100,000,000” represents an undefined data entity. The type declarations, declared above on lines 8-10, “address,” “Address,” and “data,” represent the types for memory references and for data entities, respectively. Finally, the macro routines “ACCESS_MEMORY” and “ALLOCATE_MEMORY,” declared above on lines 11-12, represent low-level memory access and memory allocation routines. These routines are simulated by the C++ pointer de-referencing operation and by the C++ operator new, respectively.

Next, a class declaration for a sparse array, implemented using a classical hierarchical data structure is provided:

| 1 class data_array | |
|---|---|
| 2 { | |
| 3 | private: |

| | |
|---|---|
| 4 | address rootBlock; |
| 5 | int levels; |
| 6 | int blockSizes[MAX_LEVEL]; |
| 7 | int referenceSizes[MAX_LEVEL]; |

| | |
|---|---|
| 8 | public: |

| | |
|---|---|
| 9 | address data_array::operator ( ) (int x); |
| 10 | int& operator [] (int x); |
| 11 | data_array(int dataBlkSz ...); |
| 12 | ˜data_array( ); |

13 };

An instance of the class “data_array” is a sparse array implemented with a classical hierarchical data structure shown in FIG. 5. The class “data_array” includes the following private data members: (1) “rootBlock,” the address of the root node of the data structure; (2) “levels,” the number of levels in the data structure above the data level; (3) “blockSizes,” an array of integers that represent the size of the blocks at each level, in entries, indexed starting with level 0; and (3) “referenceSizes,” an array of integers representing the number of data values potentially referenced by a node at each level, starting at index 0 representing level 0. The class “data_array” includes the following public members: (1) the operator “( )” for accessing a data value within an instance of the class “data_array,” which returns a null address when the data value with the index supplied as argument “x” is not defined; (2) the operator “[ ],” similar to the operator “( )” with the exception that, if the data value with index supplied as argument “x” is not defined, the necessary nodes are allocated and linked into the data structure in order to provide an entry to contain the data value, the operator “[ ]” returning a reference to the entry; and (3) a constructor and destructor.

Next, an implementation of the operator “( )” is provided:

```
  1 address data_array::operator ( ) (int x)
  2 {
```

| | |
|---|---|
| 3 | int level = levels; |
| 4 | int bin; |
| 5 | address ptr = rootBlock; |
| 6 | if (x >= referenceSizes[levels]) x = referenceSizes[levels] − 1; |
| 7 | else if (x < 0) x = 0; |
| 8 | while (level) |
| 9 | { |

| | |
|---|---|
| 10 | bin = x / referenceSizes[level − 1]; |
| 11 | x = x % referenceSizes[level − 1]; |
| 12 | if (ACCESS_MEMORY(ptr + bin * ADDRESS_SIZE) == |

| | |
|---|---|
| 13 | DISTINGUISHED_VALUE) |

| | |
|---|---|
| 14 | { |

| | |
|---|---|
| 15 | return NULL; |

| | |
|---|---|
| 16 | } |
| 17 | else ptr = address(ACCESS_MEMORY(ptr + bin * |

| | |
|---|---|
| 18 | ADDRESS_SIZE)); |

| | |
|---|---|
| 19 | level--; |

| | |
|---|---|
| 20 | } |
| 21 | if (ACCESS_MEMORY(ptr + x * DATA_SIZE) == |

| | |
|---|---|
| 22 | DISTINGUISHED_DATA_VALUE) return NULL; |

| | |
|---|---|
| 23 | else return ptr + (x * DATA_SIZE); |

24 }

The operator“( )” includes the following local variables, declared above on lines 3-5: (1) “level,” the current level being traversed within the classical hierarchical data structure; (2) “bin,” the entry index calculated for the current node of the current level; and (3) “ptr,” a pointer to the current node of the current level during a traversal. First, on lines 6-7, the index of the data value, supplied as argument “x,” is checked, and modified, if necessary, to ensure that the value “x” is within the range of indexes supported by the classical hierarchical data structure. Next, in the while-loop of lines 8-19, the classical hierarchical data structure is traversed, starting with the root node to which the local variable “ptr” is initialized on line 5. Each iteration of the while-loop corresponds to traversal of a level within the classical hierarchical data structure. On line 10, the entry index for the current node is calculated by dividing the remaining data index “x” by the number of data entries potentially referenced by an entry at the current level. Next, on line 11, the remaining data index is updated to the remainder of the above integer division. Then, the entry of the current node is accessed, on lines 12-13, and checked for being equal to the memory-reference distinguished value “DISTINGUISHED_VALUE.” If the memory reference is equal to DISTINGUISHED_VALUE, then a null address is returned on line 15, indicating that the data value with index supplied in argument “x” has not been defined. Otherwise, the local variable “ptr” is set to reference the appropriate node at the next-lowest level, on lines 17-18, and the current level is decremented, on line 19. On lines 21-22, the data-level entry corresponding to the data value indexed by the supplied argument “x” is accessed and compared to the distinguished value “DISTINGUISHED_DATA_VALUE.” If the data value is equal to DISTINGUISHED_DATA_VALUE, then a null address is returned on line 22 to indicate that the data value with index supplied in argument “x” is undefined. Otherwise, the address of the data entry is returned on line 23.

Next, an implementation of the operator “[ ]” is supplied:

1 int& data_array::operator [] (int x)
2 {

| | |
|---|---|
| 3 | int level = levels; |
| 4 | int bin, i; |
| 5 | address ptr1 = rootBlock; |
| 6 | address ptr2; |
| 7 | if (x >= referenceSizes[levels]) x = referenceSizes[levels] − 1; |
| 8 | else if (x < 0) x = 0; |
| 9 | while (level) |
| 10 | { |

| | |
|---|---|
| 11 | bin = x / referenceSizes[level − 1]; |
| 12 | x = x % referenceSizes[level − 1]; |
| 13 | ptr2 = ptr1 + (bin * ADDRESS_SIZE); |
| 14 | if (ACCESS_MEMORY(ptr2) == DISTINGUISHED_VALUE) |
| 15 | { |

| | |
|---|---|
| 16 | if (level > 1) |
| 17 | { |

| | |
|---|---|
| 18 | ptr2 = |

19
ALLOCATE_MEMORY(Address[blockSizes[level]]);

| | |
|---|---|
| 20 | for (i = 0; i < blockSizes[level]; i++) |
| 21 | { |

| | |
|---|---|
| 22 | ACCESS_MEMORY(ptr2 + (i * DATA_SIZE)) = |

| | |
|---|---|
| 23 | DISTINGUISHED_VALUE; |

| | |
|---|---|
| 24 | } |

| | |
|---|---|
| 25 | } |
| 26 | else |
| 27 | { |

| | |
|---|---|
| 28 | ptr2 = |

ALLOCATE_MEMORY(data[blockSizes[level]]);

| | |
|---|---|
| 29 | for (i = 0; i < blockSizes[level]; i++) |
| 30 | { |

| | |
|---|---|
| 31 | ACCESS_MEMORY(ptr2 + i * DATA_SIZE) = |

| | |
|---|---|
| 32 | DISTINGUISHED_DATA_VALUE; |

| | |
|---|---|
| 33 | } |

| | |
|---|---|
| 34 | } |
| 35 | ACCESS_MEMORY(ptr1 + bin * ADDRESS_SIZE) = |

| | |
|---|---|
| 36 | (Address)ptr2; |

| | |
|---|---|
| 37 | } |
| 38 | ptr1 = (address)ACCESS_MEMORY(ptr1 + bin * ADDRESS_SIZE); |
| 39 | level--; |

| | |
|---|---|
| 40 | } |
| 41 | return (int)ACCESS_MEMORY(ptr1 + x * DATA_SIZE); |

42 }

Implementation of the operator “[ ]” is quite similar to the above implementation of the operator “( ).” The primary difference between the two routines is handling of an encountered memory reference during traversal of the classical hierarchical data structure, equal to the value “DISTINGUISHED_VALUE.” In the case of operator “[ ],” if a null memory reference is encountered, then the appropriate nodes are created in order to complete the traversal and to complete a space in memory for the data value. Therefore, when a null memory-reference is encountered within a non-data-level node, as detected on line 14, above, then a new node is allocated, initialized, and an appropriate reference is included in the current node on lines 16-36. A new non-data-level node is allocated on lines 18-24, while a new data-level node is allocated on lines 28-33. A memory reference to the newly-created node is included in the current node on lines 35-36. Otherwise, implementation of operator “[ ]” is almost identical to implementation of operator “( ),” described above, and the details will therefore not be repeated, in the interest of brevity.

Next an implementation of the constructor for class “data_array” is provided:

```
  1 data_array::data_array(int dataBlkSz ...)
  2 {
```

| | |
|---|---|
| 3 | va_list ap; |
| 4 | int j; |
| 5 | levels = 0; |
| 6 | va_start(ap, dataBlkSz); |
| 7 | blockSizes[levels] = dataBlkSz; |
| 8 | referenceSizes[levels] = dataBlkSz; |
| 9 | while((j = va_arg(ap, int)) > 0 && levels < MAX_LEVEL) |
| 10 | { |

| | |
|---|---|
| 11 | levels++; |
| 12 | blockSizes[levels] = j; |
| 13 | referenceSizes[levels] = j * referenceSizes[levels − 1]; |

| | |
|---|---|
| 14 | } |
| 15 | rootBlock = ALLOCATE_MEMORY(Address[blockSizes[levels]]); |
| 16 | for (int i = 0; i < blockSizes[levels]; i++) |
| 17 | { |

| | |
|---|---|
| 18 | rootBlock[i] = DISTINGUISHED_VALUE; |

| | |
|---|---|
| 19 | } |
| 20 | va_end(ap); |

21 }

The constructor uses a variable argument list in which the sizes, in entries, of the nodes at each level of the classical hierarchical data structure, beginning with level 0, are specified. On line 5, the data member “levels” is initialized to 0, representing level 0, and the first entries in the data member arrays “blockSizes” and “referenceSizes” are set to the size, in entries, of a data-level block, on lines 7-8. Then, in the while-loop of lines 9-14, each successive specified node size is processed, and the data members “levels,” “blockSizes,” and “referenceSizes” are updated on lines 11-13. On line 15, a root node is allocated, and the root node is initialized on lines 16-19. This constructor is somewhat artificial, in order to use standard C++ features for simulating the classical hierarchical data structure.

Next, a simple routine is provided that employs an instance of the class “data_array,” in order to illustrate use of the class “data_array” in a C++-like routine:

| 1 int main(int argc, char* argv[]) | |
|---|---|
| 2 { | |
| 3 | data_array d(4,4,4,8,0); |
| 4 | int i; |
| 5 | int* a; |
| 6 | for (i = 0; i < 512; i++) d[i] = i; |
| 7 | for (i = 0; i < 512; i++) |
| 8 | { |

| | |
|---|---|
| 9 | a = d(i); |
| 10 | if (a != NULL) printf (“d[%d] = %d\n”, i, *a); |

| | |
|---|---|
| 11 | } |
| 12 | return 0; |

13 }

An instance of the class “data_array” is declared on line 3. Note that the sizes of the nodes for each level are specified in the argument list, and are equal to the sizes of the nodes of the classical hierarchical data structure illustrated in FIG. 5. On line 6, the data values within indices 0-511 are set to integer values equivalent to the indices. On lines 7-11, the data values are printed out. Of course, a sparse array would not be selected for storage of data values in the case that the sparse array is intended to be more than half filled. The above routine simply illustrates the use of the class “data_array.”

Thus, the short implementation for a classical hierarchical data structure, provided above, illustrates, in pseudocode, classical-hierarchical-data-structure traversal as described above, with reference to FIG. 5. In particular, memory accesses that occur during traversal are clearly delineated in the above implementation by calls to the memory-access function “ACCESS_MEMORY.” In the case that nodes within the classical hierarchical data structure are large, on the order of the size of a virtual memory page, it can be easily seen that, unless a very tightly grouped set of data values is repeatedly accessed, the memory accesses that occur during traversal generally incur translation-cache misses, and the attendant extra processing cycles and instruction-stream interruption.

In the following implementation, the class “data_array” is implemented as a CEHDS that represents one embodiment of the present invention. Much of the following implementation is similar to, or identical to, the above implementation, and will not be again discussed, in detail, in the interest of brevity. Instead, the differences in implementations will be pointed out to clearly indicate the differences between a CEHDS that represents one embodiment of the present invention, and a classical hierarchical data structure. First, as before, there are a number of directives, constant declarations, type declarations, and macro declarations:

```
  1 #include <stdio.h>
  2 #include <stdarg.h>
  3 const int MAX_LEVEL = 10;
  4 const int DISTINGUISHED_VALUE = 0;
  5 const int DISTINGUISHED_DATA_VALUE = −1000000000;
  6 const int DATA_SIZE = 1;
  7 const int ADDRESS_SIZE = 1;
  8 typedef int* address;
  9 typedef int Address;
10 typedef int TLB;
11 #define ACCESS_MEMORY(x) *(x)
12 #define ACCESS_MEMORY_WITH_TLB(x, y) *(x)
13 #define ALLOCATE_PINNED_MEMORY(x) new x
14 #define ALLOCATE_VIRTUAL_BASE_MEMORY(x) new x
```

Note that, in the current implementation, there is a second memory access routine “ACCESS_MEMORY_WITH_TLB,” declared above on line 12. This second memory access macro definition simulates a memory access method, such as that discussed with reference to FIG. 9, above, that takes both a virtual-memory address and a translation-cache entry as arguments. There are two memory allocation routines: (1) “ALLOCATE_PINNED_MEMORY,” declared above on line 13, that allocates a block of virtual memory that is fixed in physical memory, in the Intel IA-64 architecture, by using a special translation register; and (2) “ALLOCATE_VIRTUAL_BASE_MEMORY,” a routine that simulates a virtual-memory reservation method that reserves, but does not immediately allocate, a block of contiguous virtual-memory addresses. The latter routine is used to reserve the virtual-memory blocks for the different levels of the CEHDS, illustrated above in FIG. 7.

Next, the class declaration for class “data_array” is provided:

| 1 class data_array | |
|---|---|
| 2 { | |
| 3 | private: |

| | |
|---|---|
| 4 | address rootBlock; |
| 5 | int levels; |
| 6 | int blockSizes[MAX_LEVEL]; |
| 7 | int referenceSizes[MAX_LEVEL]; |
| 8 | address levelBases[MAX_LEVEL]; |
| 9 | TLB allocate(int level, int blk); |

| | |
|---|---|
| 10 | public: |

| | |
|---|---|
| 11 | address data_array::operator ( ) (int x); |
| 12 | int& operator [] (int x); |
| 13 | data_array(int dataBlkSz ...); |
| 14 | ˜data_array( ); |

15 };

The significant difference between this class declaration, and the previous class declaration implemented using a classical hierarchical data structure, is inclusion of a new data member “levelBases” on line 8 and a new private function member “allocate,” on line 9. The data member “levelBases” contains the virtual-memory base addresses for the levels of the CEHDS, indexed starting with level 0, and the private function member “allocate” is a memory allocation routine that returns the translation-cache entry for the allocated memory, and allocates memory for a node described by the supplied CEHDS level in argument “level” and the node index supplied as argument “blk.”

A shell for the private function member “allocate ” is provided below:

1 TLB data_array::allocate(int level, int blk)
2 {
3 TLB t;
4
5 return t;
6 }

An implementation for the allocate routine is not provided, as the allocation routine is highly dependent on operating-system services and machine-architecture details that are beyond the scope of the present invention.

Next, an implementation for the operator “( )” is provided:

```
  1 address data_array::operator ( ) (int x)
  2 {
```

| | |
|---|---|
| 3 | int level = levels; |
| 4 | int bin; |
| 5 | address ptr; |
| 6 | int currentNodeIndex = 0; |
| 7 | int offset; |
| 8 | TLB t; |
| 9 | if (x >= referenceSizes[levels]) x = referenceSizes[levels] − 1; |
| 10 | else if (x < 0) x = 0; |
| 11 | while (level) |
| 12 | { |

| | |
|---|---|
| 13 | bin = x / referenceSizes[level − 1]; |
| 14 | x = x % referenceSizes[level − 1]; |
| 15 | offset = (currentNodeIndex * blockSizes[level]) + bin; |
| 16 | ptr = address(levelBases[level] + (offset * ADDRESS_SIZE)); |
| 17 | currentNodeIndex = offset; |
| 18 | if (level == levels) t = ACCESS_MEMORY(ptr); |
| 19 | else t = ACCESS_MEMORY_WITH_TLB(ptr, t); |
| 20 | if (t == DISTINGUISHED_VALUE) return NULL; |
| 21 | level--; |

| | |
|---|---|
| 22 | } |
| 23 | ptr = address(levelBases[level] + (currentNodeIndex * |

blockSizes[level] *

| | |
|---|---|
| 24 | ADDRESS_SIZE) + (x * DATA_SIZE)); |

| | |
|---|---|
| 25 | if (ACCESS_MEMORY_WITH_TLB(ptr, t) == |

| | |
|---|---|
| 26 | DISTINGUISHED_DATA_VALUE) |
| 27 | return NULL; |

| | |
|---|---|
| 28 | else return ptr; |

29 }

The operator “( )” in the current implementation has the same form, and carries out the same function, as the operator “( )” in the above, classical-hierarchical-data-structure implementation of the class “data_array.” However, the traversal of the CEHDS is, as discussed above, significantly different. Note, first, that several additional local variables are employed in the current implementation, declared above on lines 6-8: (1) “currentNodeIndex,” the node index of the higher-level node immediately preceding a currently considered node in the CEHDS along a traversal path; (2) “offset,” the entry-based offset for the relevant entry at the current level; and (3) “t,” a local variable containing a translation-cache entry. As in the previous implementation, the current implementation of the operator “( )” traverses the data structure in the while-loop of lines 11-22, each iteration of the while-loop representing traversal of a CEHDS level. On line 13, the entry index for the relevant entry of the current level is calculated, and on line 14, the remaining data index is computed as the remainder of the integer division. Next, on line 15, an entry-based offset is computed for the relevant entry of the current node by multiplying the node index for the relevant node of the previous level by the block size, in entries, of a node at the current level and then adding the entry index for the current level. On line 16, the address of the relevant entry at the current level is next computed by adding the virtual-memory base address of the current level to the offset. Next, on line 17, the local variable “currentNodeIndex” is updated to equal the offset computed for the current level. On line 18, the memory-access routine “ACCESS_MEMORY” is employed for the root-level node and otherwise, on line 19, the memory-access routine “ACCESS_MEMORY_WITH_TLB” is employed to access the relevant entry of the current level. If the contents of the relevant entry equal the distinguished value for memory references, as determined on line 20, then a null address is returned on line 20. Otherwise, the current level is decremented, on line 21. On lines 23-24, the local “ptr” is set to the address of the data-level-node entry corresponding to the data value with index supplied as argument “x.” If the contents of the data entry equal the distinguished value for data, as determined on lines 25-26, then a null pointer is returned on line 27 to indicate that the data value has not yet been defined. Otherwise, on line 28, a pointer to the data value is returned.

Next, an implementation for the operator “[ ]” is provided:

| | |
|---|---|
| 1 | int& data_array::operator [] (int x) |
| 2 | { |

| | |
|---|---|
| 3 | int level = levels; |
| 4 | int bin; |
| 5 | address ptr; |
| 6 | int currentNodeIndex = 0; |
| 7 | int offset; |
| 8 | TLB t; |
| 9 | if (x >= referenceSizes[levels]) x = referenceSizes[levels] − 1; |
| 10 | else if (x < 0) x = 0; |
| 11 | while (level) |
| 12 | { |

| | |
|---|---|
| 13 | bin = x / referenceSizes[level − 1]; |
| 14 | x = x % referenceSizes[level − 1]; |
| 15 | offset = (currentNodeIndex * blockSizes[level]) + bin; |
| 16 | ptr = address(levelBases[level] + (offset * ADDRESS_{—} |
| | SIZE)); |
| 17 | currentNodeIndex = offset; |
| 18 | if (level == levels) t = ACCESS_MEMORY(ptr); |
| 19 | else t = ACCESS_MEMORY_WITH_TLB(ptr, t); |
| 20 | if (t == DISTINGUISHED_VALUE) |
| 21 | { |

| | |
|---|---|
| 22 | t = allocate(level − 1, offset); |
| 23 | ACCESS_MEMORY(ptr) = t |

| | |
|---|---|
| 24 | } |
| 25 | level−−; |

| | |
|---|---|
| 26 | } |
| 27 | ptr = address(levelBases[level] + (currentNodeIndex * |

blockSizes[level] *

| | |
|---|---|
| 28 | ADDRESS_SIZE) + (x * DATA_SIZE)); |

| | |
|---|---|
| 29 | return (int)ACCESS_MEMORY_WITH_TLB(ptr, t); |

| | |
|---|---|
| 30 | } |

The implementation for the operator “[ ]” is nearly the same as the above implementation for the operator “( ),” with the exception that, if a null memory reference is encountered during traversal of the CEHDS, as detected on line 20, instead of returning a null address, operator “[ ]” allocates an appropriate node and sets the entry of the current level to be the translation-cache entry corresponding to the newly allocated node on lines 22-23. Note, in particular, in the implementations of both of the operators “( )” and “[ ],” that all memory accesses, other than access to the root-level node and the second access to a node that includes a null memory reference, on line 23, above, are carried out via the memory-access routine “ACCESS_MEMORY_WITH_TLB,” which takes both a virtual-memory address and a translation-cache entry. Thus, unlike in the case of the classical hierarchical data structure, traversal of the CEHDS avoids translation-cache misses. No translation-cache miss occurs on access of the root node because, as discussed above, the virtual-memory page containing the root node is pinned in memory.

Finally, an implementation for the constuctor is provided:

| | |
|---|---|
| 1 | data_array::data_array(int dataBlkSz ...) |
| 2 | { |

| | |
|---|---|
| 3 | va_list ap; |
| 4 | int i, j; |
| 5 | TLB* tptr; |
| 6 | int nxtLvl; |
| 7 | int sz; |
| 8 | levels = 0; |
| 9 | va_start(ap, dataBlkSz); |
| 10 | blockSizes[levels] = dataBlkSz; |
| 11 | referenceSizes[levels] = dataBlkSz; |
| 12 | while((j = va_arg(ap, int)) > 0 && levels < MAX_LEVEL) |
| 13 | { |

| | |
|---|---|
| 14 | levels++; |
| 15 | blockSizes[levels] = j; |
| 16 | referenceSizes[levels] = j * referenceSizes[levels − 1]; |

| | |
|---|---|
| 17 | } |
| 18 | nxtLvl = blockSizes[levels]; |
| 19 | rootBlock = ALLOCATE_PINNED_MEMORY(TLB[nxtLvl]); |
| 20 | for (i = 0; i < nxtLvl; i++) |
| 21 | { |

| | |
|---|---|
| 22 | rootBlock[i] = DISTINGUISHED_VALUE; |

| | |
|---|---|
| 23 | } |
| 24 | for(j = levels − 1; j > 0; j−−) |
| 25 | { |

| | |
|---|---|
| 26 | sz = blockSizes[j] * nxtLvl * ADDRESS_SIZE; |
| 27 | tptr = levelBases[j] = |

ALLOCATE_VIRTUAL_BASE_MEMORY(TLB[sz]);

| | |
|---|---|
| 28 | for (i = 0; i < sz; i++) tptr[i] = DISTINGUISHED_{—} |
| | VALUE; |
| 29 | nxtLvl = nxtLvl * blockSizes[j]; |

| | |
|---|---|
| 30 | } |
| 31 | sz = blockSizes[0] * nxtLvl * DATA_SIZE; |
| 32 | tptr = levelBases[0] = ALLOCATE_VIRTUAL_BASE_{—} |
| | MEMORY(TLB[sz]); |
| 33 | for (i = 0; i < sz; i++) tptr[i] = DISTINGUISHED_DATA_{—} |
| | VALUE; |
| 34 | nxtLvl = nxtLvl * blockSizes[j]; |
| 35 | levelBases[levels] = rootBlock; |
| 36 | va_end(ap); |

| | |
|---|---|
| 37 | } |

In the above constructor implementation, the data member “levelBases” is initialized in the fore-loop of lines 24-31, as part of allocation of the contiguous blocks of virtual memory for the CEHDS levels using the memory-allocation routine “ALLOCATE_VIRTUAL_BASE_MEMORY.” Otherwise, the constructor is similar to the previously discussed constructor for the classical-hierarchical-data-structure implementation.

Although the present invention has been described in terms of a particular embodiment, it is not intended that the invention be limited to this embodiment. Modifications within the spirit of the invention will be apparent to those skilled in the art. For example, as discussed above, there are many different types of hierarchical data structures, such as the hierarchical data structure shown in FIG. 5, that together compose a family of hierarchical data structures that employ stored memory-reference entries to interconnect nodes of the hierarchical data structures. Any of these various types of hierarchical data structures can be modified, as discussed above, to produce a corresponding CEHDS, each of which represents an alternative embodiment of the present invention. For example, the number of levels in the hierarchical data structure, the number of entries in each node of each level, and many other aspects of both the classical hierarchical data structures and the corresponding CEHDS may be modified. Non-data-level nodes of the CEHDS may contain information in addition to translation-cache entries. For various different machine architectures, quantities other than translation-cache entries may be stored that allow translation-cache-miss avoidance. For example, other processor architectures may not employ a translation-cache, but may employ other types of specialized registers or dedicated physical memory for caching virtual-memory-to-physical-memory translations, and appropriate entries or values for these alternate translation-storage mechanisms can be placed in a CEHDS for that machine architecture. The present invention is relevant to CEHDS used to implement a variety of different sparse-data-storage entities, including sparse arrays, as discussed above with reference to example implementations, and, more particularly, to page tables and other massive sparse data entities created and managed by operating systems.

The foregoing description, for purposes of explanation, used specific nomenclature to provide a thorough understanding of the invention. However, it will be apparent to one skilled in the art that the specific details are not required in order to practice the invention. The foregoing descriptions of specific embodiments of the present invention are presented for purpose of illustration and description. They are not intended to be exhaustive or to limit the invention to the precise forms disclosed. Obviously many modifications and variations are possible in view of the above teachings. The embodiments are shown and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents:

1. A method for storing a data entity having an index in a computer within a data structure having multiple node levels, the method comprising:
providing a hierarchical data structure for indexing stored data entities, the hierarchical data structure having a root level, one or more intermediate levels, and a data level, each level containing at least one node, each node having at least one entry;
storing virtual-memory translations for an address of a lower-level node in each intermediate and root node;
traversing the levels of the hierarchical data structure, starting from a root node, accessing each lower-level node on a traversal path using a virtual-memory translation obtained from a next highest level node; and
storing the data entity in a lowest level node.

2. The method of claim 1 wherein the levels of the hierarchical data structure each correspond to a block of contiguous virtual-memory addresses and is associated with a base virtual-memory address.

3. The method of claim 2 wherein traversing the levels of the hierarchical data structure, starting from a root node, accessing each lower-level node using a virtual-memory translation obtained from a next highest level node further includes:
initializing a remaining data index to the index of the data entity;
initializing a current node index to 0;
initializing a current level to the root level;
at each level,
computing an entry index as an integer dividend of the remaining data index by a number of data values potentially referenced by the current node;
setting the remaining data index to a remainder of the integer division by which the entry index is computed;
computing a virtual-memory address of a relevant entry in a current node of the current level on the traversal path;
accessing the relevant entry to obtain a translation-cache entry;
setting the current node index to the node index of a node of a next lowest level on the traversal path; and
setting the current level to that of the next lowest level.

4. The method of claim 3 wherein computing a virtual-memory address of a relevant entry in the current node further comprises:
adding to the base virtual-memory address of the current level a size of the relevant entry multiplied by the entry index and a size of the current node multiplied by the current node index.

5. The method of claim 3 wherein accessing the relevant entry to obtain a translation-cache entry further includes, for intermediate levels, using a translation-cache entry obtained from a node on the traversal path at the next highest level and the computed virtual-memory address of the relevant entry to access the relevant entry without incurring a translation-cache miss.

6. The method of claim 3 wherein setting the current node index to the node index of a node of a next lowest level on the traversal path further comprises:
setting the current node index to the entry index added to the sum of the node index of the current node and the number of entries in the current node.

7. The method of claim 3 wherein setting the current level to that of the next lowest level further comprises decrementing the current level.

8. Computer instructions that implement the method of claim 1 stored in a computer readable format on a computer readable medium.

9. Data stored according to the method of claim 1 in electronic memory of one or more computer systems.

10. A method for transforming a hierarchical data structure that includes virtual-memory addresses in a root node and in intermediate level nodes into a computationally efficient hierarchical data structure, the method comprising:
arranging nodes of each level within contiguous blocks of virtual memory having base addresses, so that a position of a node within a level can be calculated as the base address for the level added to a node size for the level multiplied by an index for the node within the level;
replacing the virtual-memory addresses within the root node and intermediate-level nodes with translation cache entries corresponding to the virtual-memory addresses; and
when traversing the levels of the computationally efficient hierarchical data structure, starting from a root node, accessing each lower-level node on a traversal path using a virtual-memory translation obtained from a next highest level node.

11. The method of claim 10 wherein traversing the levels of the computationally efficient hierarchical data structure, starting from a root node, accessing each lower-level node using a virtual-memory translation obtained from a next highest level node further includes:
initializing a remaining data index to the index of the data entity;
initializing a current node index to 0;
initializing a current level to the root level;
at each level,
computing an entry index as an integer dividend of the remaining data index by a number of data values potentially referenced by the current node;
setting the remaining data index to a remainder of the integer division by which the entry index is computed;
computing a virtual-memory address of a relevant entry in a current node of the current level on the traversal path;
accessing the relevant entry to obtain a translation-cache entry;
setting the current node index to the node index of a node of a next lowest level on the traversal path; and
setting the current level to that of the next lowest level.

12. The method of claim 11 wherein computing a virtual-memory address of a relevant entry in the current node further comprises:
adding to the base virtual-memory address of the current level a size of the relevant entry multiplied by the entry index and a size of the current node multiplied by the current node index.

13. The method of claim 11 wherein accessing the relevant entry to obtain a translation-cache entry further includes, for intermediate levels, using a translation-cache entry obtained from a node on the traversal path at the next highest level and the computed virtual-memory address of the relevant entry to access the relevant entry without incurring a translation-cache miss.

14. The method of claim 11 wherein setting the current node index to the node index of a node of a next lowest level on the traversal path further comprises:
setting the current node index to the entry index added to the sum of the node index of the current node and the number of entries in the current node.

15. Computer instructions that implement the method of claim 10 stored in a computer readable format on a computer readable medium.

16. Data stored according to the method of claim 10 in electronic memory of one or more computer systems.

17. A method for storing data entities in a computer within a data structure having multiple levels of nodes, the method comprising:
allocating memory for a root node;
determining a number of levels for the data structure, including a root level, intermediate non-data-level levels, and a data level;
determining a number of entries for nodes of each level;
reserving contiguous virtual-memory blocks for intermediate levels; and
when storing a next data entity having a next data index,
setting a current node as the root node, a current level as a highest level of the data structure, and a remaining data index as the next data index,
while the current level is greater than a lowest, data level,
calculating a current entry index by an integer division of the remaining data index by a product of the number of entries for nodes of each level of the data structure below the current level,
setting the remaining data index to a remainder of the integer division,
accessing an entry in the current node indexed by the current entry index to obtain a virtual-memory translation,
when the virtual-memory translation has a distinguished value,
allocating a new node for the next lowest level from the corresponding contiguous virtual-memory block for the next lowest level, and
placing a virtual-memory translation for the new node into the entry in the current node indexed by the current entry index, and
updating the current node to the node of a next lowest level node having a node index obtained by setting the current node index to the current entry index added to the sum of the node index of the current node and the number of entries in the current node, and
setting the current level to a next lowest level of the data structure;
storing the data value in an entry in the current node indexed by the remaining data index.

18. Computer instructions that implement the method of claim 10 stored in a computer readable format.

19. Data stored according to the method of claim 10 in electronic memory of one or more computer systems.

20. A system for storing and retrieving data comprising:
a computer system having a virtual memory;
a number of reserved blocks of contiguous virtual memory, each reserved block corresponding to a level, including a highest, root level, one or more intermediate levels, and a lowest, data level;
a computationally efficient hierarchical data structure that includes at least one node in each reserved block corresponding to each level, each node in a level higher than the data level containing translation-cache entries corresponding to the virtual addresses of nodes in the next lowest level, and each node in the lowest level containing data; and
computer routines for traversing the computationally efficient hierarchical data structure to locate an entry in a data-level node corresponding to a data value with a specified index.

21. The system of claim 20 wherein the computer routines traverse the levels of the computationally efficient hierarchical data structure, starting from a root node, accessing each lower-level node using a virtual-memory translation obtained from a next highest level node by:
initializing a remaining data index to the index of the data entity;
initializing a current node index to 0;
initializing a current level to the root level;
at each level,
computing an entry index as an integer dividend of the remaining data index by a number of data values potentially referenced by the current node;
setting the remaining data index to a remainder of the integer division by which the entry index is computed;
computing a virtual-memory address of a relevant entry in a current node of the current level on the traversal path;
accessing the relevant entry to obtain a translation-cache entry;
setting the current node index to the node index of a node of a next lowest level on the traversal path; and
setting the current level to that of the next lowest level.

22. The system of claim 21 wherein computing a virtual-memory address of a relevant entry in the current node further comprises:
adding to the base virtual-memory address of the current level a size of the relevant entry multiplied by the entry index and a size of the current node multiplied by the current node index.

23. The method of claim 21 wherein accessing the relevant entry to obtain a translation-cache entry further includes, for intermediate levels, using a translation-cache entry obtained from a node on the traversal path at the next highest level and the computed virtual-memory address of the relevant entry to access the relevant entry without incurring a translation-cache miss.

24. The method of claim 21 wherein setting the current node index to the node index of a node of a next lowest level on the traversal path further comprises:
setting the current node index to the entry index added to the sum of the node index of the current node and the number of entries in the current node.

25. The method of claim 21 wherein setting the current level to that of the next lowest level further comprises decrementing the current level.
